(19) United States
(12) Patent Application Publication
(10) Pub. No.: US 2026/0360382 A1
(43) Pub. Date: Nov. 12, 2026

(54) PROCESSING AUDIO DATA

(71) Applicant: Nokia Technologies Oy, Espoo (FI)

(72) Inventors: Miikka Tapani VILERMO, Tampere (FI); Arto Juhani LEHTINIEMI, Tampere (FI); Antti Johannes ERONEN, Tampere (FI)

(21) Appl. No.: 19/570,689

(22) Filed: Mar. 18, 2026

(30) Foreign Application Priority Data
May 9, 2025 (FI) 20253184

(51) Int. Cl. G10L 25/27; G10L 25/78

(52) U.S. Cl. CPC G10L 25/27; G10L 25/78

(57) ABSTRACT

Disclosed is solution for processing audio data and associated metadata. At least one stream of audio data comprising first metadata associated with the audio data of the stream is obtained (300). The at least one stream of audio data is classified (302) and based on the classification, adjustment of the first metadata of the at least one stream of audio data for increased and decreased speed of the stream of audio data is determined (304). Information on the determined adjustment is stored (306) to a second metadata and the at least one stream of audio data is outputted (308) with the first and the second metadata.

### RELATED APPLICATION

This application claims priority to Finnish Patent Application No. 20253184, filed May 9, 2025, the content of which is incorporated herein by reference in its entirety.

### FIELD

The following example embodiments relate to processing audio data and associated metadata.

### BACKGROUND

Audio data, whether standalone audio or audio associated with a video feed or Voice over Internet Protocol (VOIP), for example, is usually played in normal speed. Sometimes there arises a need for playing the audio slower or faster than it was captured. This may happen by a request or command by the user or due to errors or problems in communication, for example due to lost packets in the audio data stream.

The use of spatial audio is also becoming more and more common. Spatial audio is a technology that enhances sound by creating a three-dimensional listening experience. Spatial audio employs multiple channels to place sounds all around the listener. This gives the impression that sounds are coming from various directions and distances, making the audio experience more realistic and immersive.

Spatial audio is also considered for mobile communication environment. A suitable codec for spatial audio is currently under study. Special consideration is needed when spatial audio is played in slow or fast motion.

### SUMMARY

The scope of protection sought for various example embodiments is set out by the claims. The example embodiments and features, if any, described in this specification that do not fall under the scope of the claims are to be interpreted as examples useful for understanding various embodiments.

### BRIEF DESCRIPTION OF THE DRAWINGS

In the following, various example embodiments will be described in greater detail with reference to the accompanying drawings, in which

FIG. 1 illustrates an example of a wireless communication network;

FIGS. 2A, 2B and 2C illustrate an example of a situation where the speed of audio data varies;

FIGS. 3 and 4 illustrate flow charts according to some embodiments;

FIGS. 5A, 5B, 5C and 5D illustrate examples of adjusting data;

FIGS. 6A-6F illustrate further example embodiments;

FIGS. 7 and 8 illustrate examples of apparatuses of some embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments within the scope of the claims. Furthermore, the words "comprising" and "including" should be understood as not limiting the described embodiments to consist of only those features that have been mentioned, and such embodiments may also contain features that have not been specifically mentioned. Reference numbers, in the description and/or in the claims, serve to illustrate the embodiments with reference to the drawings, without limiting the embodiments to these examples only.

Some example embodiments described herein may be implemented in a wireless communication network comprising a radio access network based on one or more of the following radio access technologies (RATs): fourth generation (4G), fifth generation (5G), 5G new radio (NR), 5G-Advanced (i.e., 3GPP NR Rel-18 and beyond), sixth generation (6G), or seventh generation (7G). Some examples of radio access networks include the universal mobile telecommunications system (UMTS) radio access network (UTRAN), the evolved universal terrestrial radio access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications. IEEE is an abbreviation for the Institute of Electrical and Electronics Engineers.

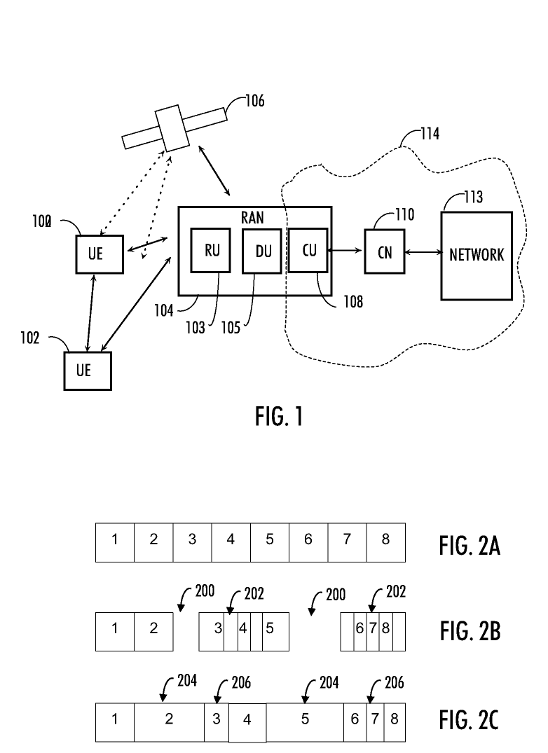

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the example embodiments described herein to other wireless communication networks provided with necessary properties.

The example wireless communication network shown in FIG. 1 includes a radio access network (RAN) and a core network 110.

FIG. 1 shows terminal device or user equipment (UE) 100, 102 configured to be in a wireless connection on one or more communication channels in a radio cell with an access node 104 of a radio access network.

The access node 104 may comprise a computing device configured to control the radio resources of the access node 104 and to be in a wireless connection with one or more UEs 100, 102. The access node 104 may also be referred to as a base station, a base transceiver station (BTS), an access point, a cell site, a network node, a radio access network node, a RAN node, or a network device.

The access node 104 may be, for example, an evolved NodeB (abbreviated as eNB or eNodeB), or a next generation evolved NodeB (abbreviated as ng-eNB), or a next generation NodeB (abbreviated as gNB or gNodeB), providing the radio cell. The access node 104 may include or be coupled to transceivers. From the transceivers of the access node 104, a connection may be provided to an antenna unit that establishes a bi-directional radio link to one or more UEs 100, 102. The antenna unit may comprise an antenna or antenna element, or a plurality of antennas or antenna elements.

The wireless connection (e.g., radio link) from a UE 100, 102 to the access node 104 may be called uplink (UL) or reverse link, and the wireless connection (e.g., radio link) from the access node 104 to the UE 100, 102 may be called downlink (DL) or forward link. A UE 100 may also communicate directly with another UE 102, and vice versa, via a wireless connection generally referred to as a sidelink (SL). It should be appreciated that the access node 104 or its functionalities may be implemented by using any node, host, server, access point or other entity suitable for providing such functionalities.

The radio access network may comprise more than one access node 104, in which case the access nodes may also be configured to communicate with one another over wired or wireless links. These links between access nodes may be used for sending and/or receiving control plane signaling and also for routing data from one access node to another access node.

The access node 104 may further be connected to a core network (CN) 110. The core network 110 may comprise an evolved packet core (EPC) network and/or a 5^{th} generation core network (5GC). The EPC may comprise network entities, such as a serving gateway (S-GW for routing and forwarding data packets), a packet data network gateway (P-GW) for providing connectivity of UEs to external packet data networks, and/or a mobility management entity (MME). The 5GC may comprise one or more network functions, such as at least one of: a user plane function (UPF), an access and mobility management function (AMF), a location management function (LMF), and/or a session management function (SMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

It should also be understood that the distribution of functions between core network operations and access node operations may differ in future wireless communication networks compared to that of the LTE or 5G, or even be non-existent.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device, just to mention but a few names. The UE 100, 102 may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or a computing device comprising a wireless modem integrated in a vehicle.

It should be appreciated that the UE 100, 102 may also be a nearly exclusive uplink-only device, of which an example may be a camera or video camera loading images or video clips to a network. The UE 100, 102 may also be a device having capability to operate in an Internet of Things (IoT) network, which is a scenario in which objects may be provided with the ability to transfer data over a network without requiring human-to-human or human-to-computer interaction.

The wireless communication network may also be able to support the usage of cloud services. For example, at least part of core network operations may be carried out as a cloud service (this is depicted in FIG. 1 by “cloud” 114). The UE 100, 102 may also utilize the cloud 114. In some applications, the computation for a given UE may be carried out in the cloud 114 or in another UE.

The wireless communication network may also comprise a central control entity, such as a network management system (NMS), or the like. The NMS is a centralized suite of software and hardware used to monitor, control, and administer the network infrastructure. The NMS is responsible for a wide range of tasks such as fault management, configuration management, security management, performance management, and accounting management. The NMS enables network operators to efficiently manage and optimize network resources, ensuring that the network delivers high performance, reliability, and security.

5G enables using multiple-input and multiple-output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine-type applications, such as (massive) machine-type communications (mMTC), including vehicular safety, different sensors and real-time control.

In 5G wireless communication networks, access nodes and/or UEs may have multiple radio interfaces, such as below 6 gigahertz (GHz), centimeter wave (cmWave) and millimeter wave (mmWave), and also being integrable with legacy radio access technologies, such as LTE. Integration with LTE may be implemented, for example, as a system, where macro coverage may be provided by LTE, and 5G radio interface access may come from small cells by aggregation to LTE. In other words, a 5G wireless communication network may support both inter-RAT operability (such as interoperability between LTE and 5G) and inter-RI operability (inter-radio interface operability, such as between below 6GHz, cmWave, and mmWave).

5G wireless communication networks may also apply network slicing, in which multiple independent and dedicated virtual sub-networks (network instances) may be created within the same physical infrastructure to run services that have different requirements on latency, reliability, throughput and mobility.

5G may enable analytics and knowledge generation to occur at the source of the data. This approach may involve leveraging resources that may not be continuously connected to a network, such as laptops, smartphones, tablets and sensors. Multi-access edge computing (MEC) may provide a distributed computing environment for application and service hosting. It may also have the ability to store and process content in close proximity to cellular subscribers for faster response time. Edge computing may cover a wide range of technologies, such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

In one embodiment, an access node 104 may comprise: a radio unit (RU) 103 comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node 104 may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node 104. The CU 108 may comprise a control plane (CU-CP), which may be a logical node hosting the RRC and the control plane part of the PDCP protocol of the NR protocol stack for the access node 104. The CU 108 may further comprise a user plane (CU-UP), which may be a logical node hosting the user plane part of the PDCP protocol and the SDAP protocol of the CU for the access node 104.

The DU 105 may be a logical node hosting radio link control (RLC), medium access control (MAC) and/or physical (PHY) layers of the NR protocol stack for the access node 104. The operations of the DU 105 may be at least partly controlled by the CU 108. It should also be understood that the distribution of functions between the DU 105 and the CU 108 may vary depending on the implementation.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the radio access network by utilizing network function virtualization (NFV) and software defined networking (SDN). Using edge cloud may mean access node operations to be carried out, at least partly, in a computing system operationally coupled to a remote radio head (RRH) or a radio unit (RU) 103 of an access node 104. It is also possible that access node operations may be performed on a distributed computing system or a cloud computing system located at the access node 104. Application of cloud RAN architecture enables RAN real-time functions being carried out at the radio access network (e.g., in a DU 105), and non-real-time functions being carried out in a centralized manner (e.g., in a CU 108).

5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network 110, enabling more extensive network coverage. Possible use cases may include: providing service continuity for machine-to-machine (M2M) or Internet of Things (IoT) devices or for passengers on board of vehicles, or ensuring service availability for critical communications, and future railway, maritime, or aeronautical communications. Satellite communication may utilize geostationary earth orbit (GEO) satellite systems, or low earth orbit (LEO) satellite systems, such as mega-constellations (i.e., systems in which hundreds of (nano)satellites are deployed). Alternatively, the satellites may be an airborne devices, such as an unmanned aerial vehicle (UAV), or a high-altitude platform system (HAPS). A given satellite 106 may provide communication services on Earth via one or more satellite beams. The one or more satellite beams create one or more cells over a given service area that may be bounded by the field of view of the satellite 106.

It is obvious for a person skilled in the art that the access node 104 depicted in FIG. 1 is just an example of a part of a radio access network, and in practice the radio access network may comprise a plurality of access nodes 104, the UEs 100, 102 may have access to a plurality of radio cells, and the radio access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of a radio access network, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) 104 of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of radio access networks, the concept of “plug-and-play” access nodes may be introduced. A radio access network, which may be able to use “plug-and-play” access nodes, may include, in addition to Home eNodeBs or Home gNodeBs, a Home Node B gateway (HNB-GW) (not shown in FIG. 1). An HNB-GW, which may be installed within an operator’s radio access network, may aggregate traffic from a large number of Home eNodeBs or Home gNodeBs back to a core network 110 of the operator.

6G wireless communication networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is envisaged that 7G, which will succeed the 5G and 6G technologies, will be able to satisfy the requirements of extremely high bandwidth, almost zero latency, and universal integration.

Some example embodiments are described below using principles and terminology of 5G radio access technology without limiting the example embodiments to 5G radio access technology, however.

Spatial audio parameters are used in many use cases e.g. low bitrate compressed spatial audio, flexible rendering of spatial audio to different speaker setups. The upcoming 3GPP Immersive Voice and Audio Services (IVAS) codec has spatial audio parameters. Spatial audio has been used in theatres supporting surround sound or home theaters. For example, Dolby^{TM} Atmos uses spatial audio parameters.

Spatial audio is a technology that delivers a captivating audio experience by mimicking sound in a three-dimensional environment. Spatial audio can make it feel like sounds are coming from all directions – above, below, in front, behind, and to the sides.

Spatial audio is commonly used in virtual reality (VR), augmented reality (AR), and sophisticated audio systems to make the audio experience more realistic for the listener. For example, when watching a movie or playing a game with spatial audio and suitable equipment, the user may hear footsteps coming from behind or a plane flying overhead, which makes the experience more immersive. Also UEs or terminal devices are nowadays commonly used for playing audio and video streams. Also, the use of Voice over Internet (VOIP) audio and video calls is widespread.

Audio data may comprise metadata, which comprises information on how the audio should be played. The metadata may comprise, for example, frequency spectrum and direction information.

Metadata may provide information about how audio should be rendered in a three-dimensional space. Metadata may provide information regarding positioning, head-tracking data and coherence, for example. Metadata can comprise information on the position of sound sources in a three-dimensional space. This enables audio systems accurately place sounds around the listener, creating an immersive experience. For VR applications, metadata may include head-tracking information. This allows the audio to adjust dynamically based on the listener's head movements, ensuring that sounds remain consistent with the visual environment. In addition, metadata may ensure that spatial audio content is compatible with various playback systems and devices. It may include information about the audio format, sample rate, channel configuration, direction, coherence, and reverberation, for example.

Occurrences when the audio of an audio stream or a video stream may be slowed down or played faster happens now and then, for example with slow/fast motion video and in VOIP calls to allow more time for delayed packets to arrive and to catch up after lost or delayed packets. In addition, the user may manually select slower or fasted playback.

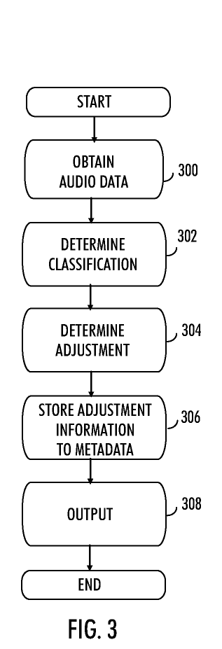

FIGS. 2A, 2B and 2C illustrate an example of a situation where the speed of audio data varies. FIG. 2A illustrates the original audio data where the speed of the packets has not been changed. FIG. 2B illustrates a situation where there are gaps 200 between some packets and some packets 202 are overlapping because packets have arrived late. FIG. 2C illustrates an example where some packets 204 are played with decreased speed (in slow motion) and some packets 206 are played with increased speed (in fast motion) to hide the gaps.

In general, spatial audio metadata is quantized, i.e., it has a time resolution. The time resolution is typically 5-20ms. When audio is slowed down or played faster during playback, the metadata time resolution in typical parametric spatial audio becomes too coarse or dense. When audio is slowed down, there is typically a need to create metadata between original metadata samples. When audio is sped up, there is typically a need to reduce the amount of metadata by averaging or discarding metadata samples or using any suitable means to reduce the amount of metadata.

Pure audio data (i.e. not metadata) slow/fast motion audio can be created with many known methods. These methods are known in the art and are not described here in detail. There are methods based on resampling and pitch shifting, there are methods where the audio signal is parameterized to sinusoids and noise and the parameters of those are modified to create slow motion audio, for example.

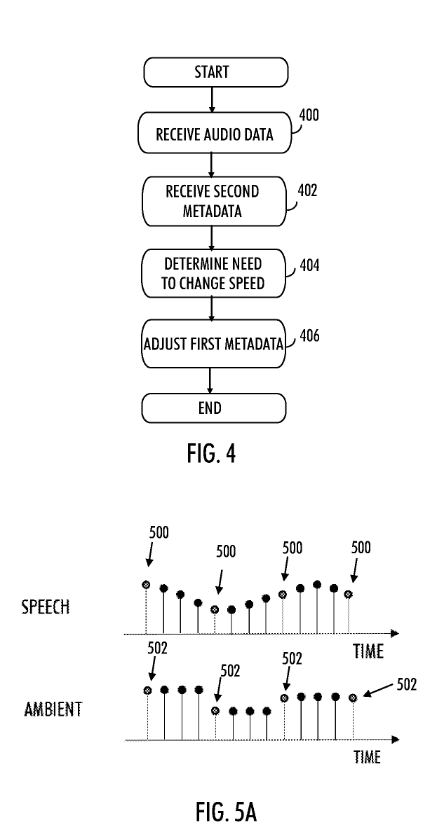

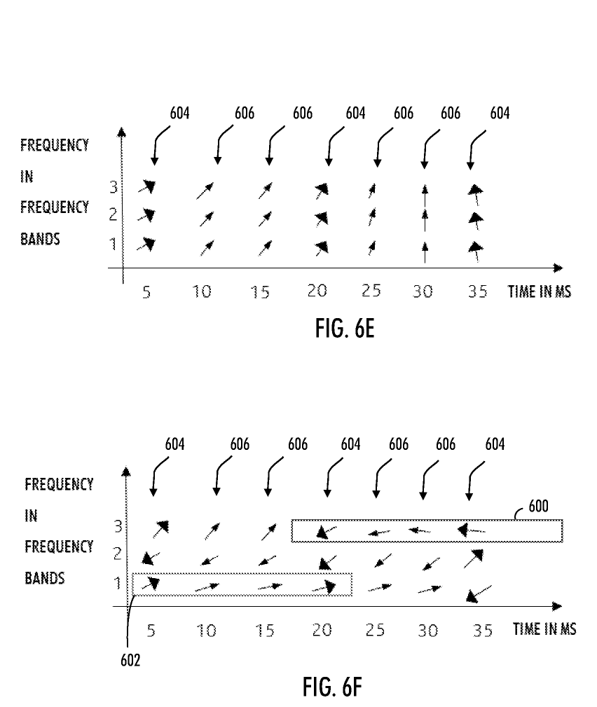

FIG. 3 illustrates a flow chart according to an example embodiment of a method for processing audio data and metadata associated with the audio data. The method may be performed by an apparatus 700 depicted in FIG. 7. For example, the apparatus may be, or comprise, any device capable of capturing or encoding streams of audio data.

In step 300, the apparatus is configured to obtain at least one stream of audio data comprising first metadata associated with the audio data of the stream.

The audio stream may be mono, stereo binaural multichannel or any kinds of audio signal having associated metadata. The metadata may be spatial audio metadata, i.e., it comprises information on how the audio should be played spatially. Parameters may relate to audio directions and coherence. The use of such parameters may also be improved with additional metadata that describes how such parameters should be interpolated.

In step 302, the apparatus is configured to determine classification of the at least one stream of audio data.

Classification as such can be performed done using known methods. Classification is based on the properties of the stream of audio data. The difference in classification may be quite detailed such as one speaker vs. multiple speakers or live music vs. recorded music. Different classes the stream of audio data may be classified to typically comprise speech, ambience, music, noise alarm sounds, traffic noise, wind noise, animal sounds etc. Speech may be any speech, speech from a known user only, speech from close by speech sources, speech signal with noise cancellation and/or reverberation cancellation, for example. Ambience may be any audio other than speech, speech subtracted from all audio, only distant sound sources, sound sources without specific direction, for example.

For example, a stream of audio data may be classified as speech if the audio data has a single strongest audio source which is spatially slowly moving based on the first metadata of the stream,.

Likewise, a stream of audio data may be classified as ambient audio if the audio data has a plurality of audio sources which are spatially fast moving based on the first metadata of the stream.

In an embodiment, the classification of a stream of audio data may comprise different classifications for different sections of the stream of audio data. For example, a stream of audio data may first comprise speech and later change to ambience or background noise.

The first metadata may comprise many kinds of metadata. For example: direction (azimuth, elevation), distance, second direction, energy ratios: D/A ratio, reverberation, spatial extent, spatial coherence, for example.

In step 304, the apparatus is configured to determine, based on the classification, adjustment of the first metadata of the at least one stream of audio data if there is a need to either increase or decrease the speed of the stream of audio data.

Thus, metadata associated with a stream of audio data may be adjusted differently depending on the classification of the audio data. Metadata of a stream comprising speech may be adjusted in a different manner compared to metadata of a stream comprising ambience, for example.

In step 306, the apparatus is configured to store information on the determined adjustment to a second metadata.

In step 308, the apparatus is configured to output the at least one stream of audio data with the first and the second metadata.

Thus, the apparatus is configured to determine second metadata which indicates how the first metadata or spatial audio metadata is to be adjusted if there is a need to either increase or decrease the speed of the stream of audio data and output the stream of audio data with both the first and second metadata.

In an embodiment, the apparatus is configured to encode the second metadata to the at least one stream of audio data. For example, the second metadata may be combined with the first metadata and transmitted together with the stream of audio data.

In an embodiment, the apparatus may be configured to encode the second metadata separately from the at least one stream of audio data. The stream of audio data and the associated first metadata and the second metadata may be transmitted in different data packets, for example.

In an embodiment, the above steps may be performed by an apparatus performing capturing or encoding streams of audio data. The steps need not be performed by a single apparatus, but the tasks may be divided between more than one apparatus. The steps need not be performed in real time but naturally they may be done so. In an embodiment, the resulted output with the at least one stream of audio data with the first and the second metadata may be stored in memory, or transmitted to a receiving apparatus which may be an audio/video player or a VR device, for example, either directly or via memory storage.

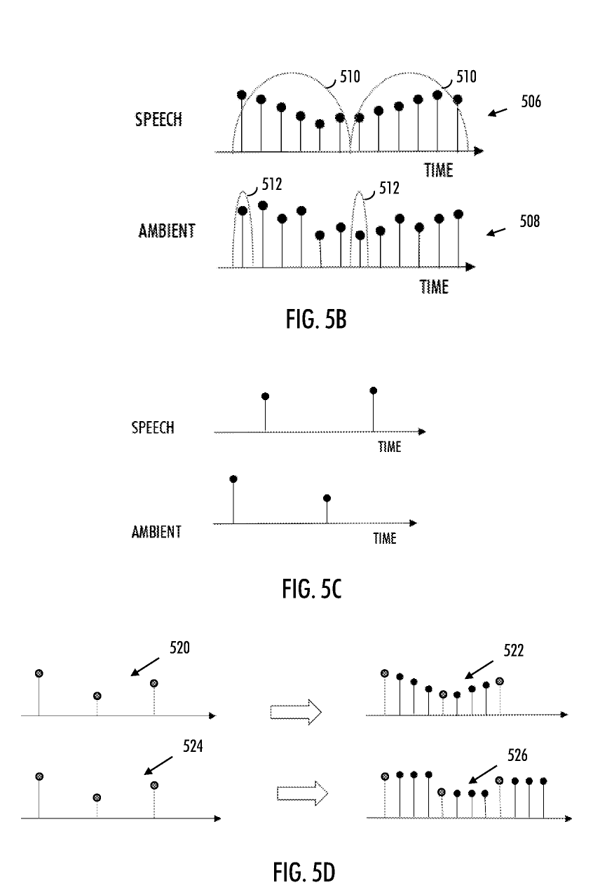

FIG. 4 illustrates a flow chart according to an example embodiment of a method for processing audio data and metadata associated with the audio data. The apparatus may be, or comprise, any device capable of receiving and playing streams of audio data.

In step 400, the apparatus is configured to receive one or more streams of audio data, at least one stream comprising first metadata associated with the audio data of the stream.

In step 402, the apparatus is configured to receive second metadata associated with the at least one stream, the second metadata comprising instructions on how the first metadata is to be adjusted if there is a need to either increase or decrease the speed of the stream of audio data. The at least one stream comprising first metadata may also comprise the second metadata. The second metadata may also have been encoded separately from the at least one stream and received in connection with the stream comprising first metadata ore received separately.

In step 404, the apparatus is configured to determine a need to either increase or decrease the speed of the one or more streams of audio data.

The need to change the speed may be a commend from the user of the device or it may depend on the reception of the one or more streams of audio data. For example, problems in communication or reception may cause the need to adjust the playback speed of the stream of audio data. If the audio data is associated with a video, and the speed of video is changed the speed of audio must be adjusted correspondingly.

In step 406, the apparatus is configured to adjust the first metadata of the at least one stream, wherein the adjustment is based on the second metadata and the need to either increase or decrease the speed.

Let us study the adjustment of metadata. In an embodiment, the adjustment of metadata when audio stream is slowed or sped up, may depend on the type of the audio, i.e., the classification of the audio stream. For streams, which can be considered to consist mostly of sound sources where one or a few sound sources dominate the track audio (such as speech), the metadata may be smoothed and/or interpolated between original metadata samples. Whereas streams, where dominant source constantly changes (such as typically ambient audio), the new metadata points between original points may just repeat original metadata values without or with less smoothing.

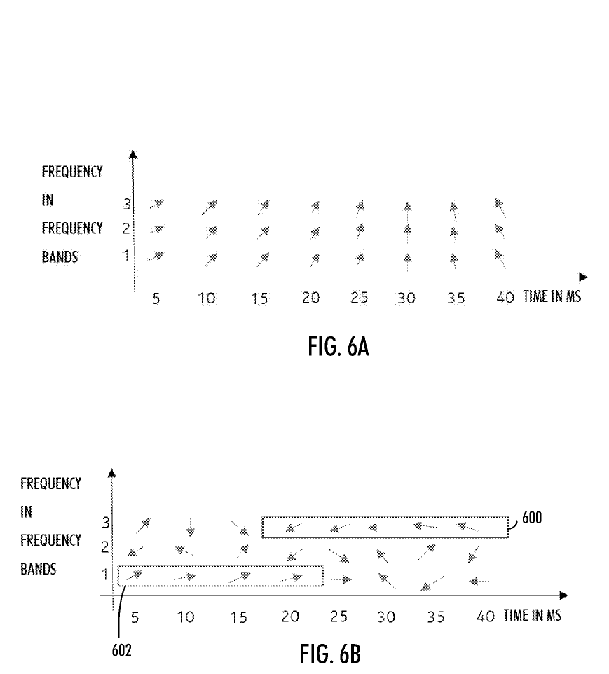

FIG. 5A illustrates an example of adjusting metadata when streams are to be slowed down. Metadata values are added to the stream. For speech, the added metadata 500 is interpolated within the original values whereas for ambient, the added metadata 502 repeat original metadata values.

FIGS. 5B and 5C illustrate an example of adjusting metadata when streams are to be sped up. In an embodiment, the metadata can be, for example, averaged or extra metadata can be discarded depending on the audio characteristics. For example, speech spatial metadata may be averaged with a long averaging window (10ms or more before speeding up, typically multiple samples of the same spatial metadata fit inside the window). Ambience spatial metadata can be averaged with a shorter averaging window or only the current spatial metadata value is kept, and others are discarded.

FIG. 5B illustrates the original speech and ambience streams. The Figure illustrates obtained streams of audio data, where a first stream 506 of audio data is classified as speech and a second stream 508 of audio data is classified as ambient.

When the speed of the streams is to be increased, the adjustment of the first metadata of the first and second streams is determined to be averaging, wherein the first metadata of the first stream is averaged with a longer time-window than the first metadata of the second stream.

Results of the averaging are shown in FIG. 5C.

FIG. 5D illustrates an example of adjusting the stream of audio by interpolation, when the speed of the streams is to be decreased. In FIG. 5D, there is a first stream 520 classified as speech. The interpolation 522 smooths the data. There is also a second stream 524 classified as ambience. The interpolation 526 repeats the data. The metadata of the first stream is interpolated smoother than the metadata of the second stream.

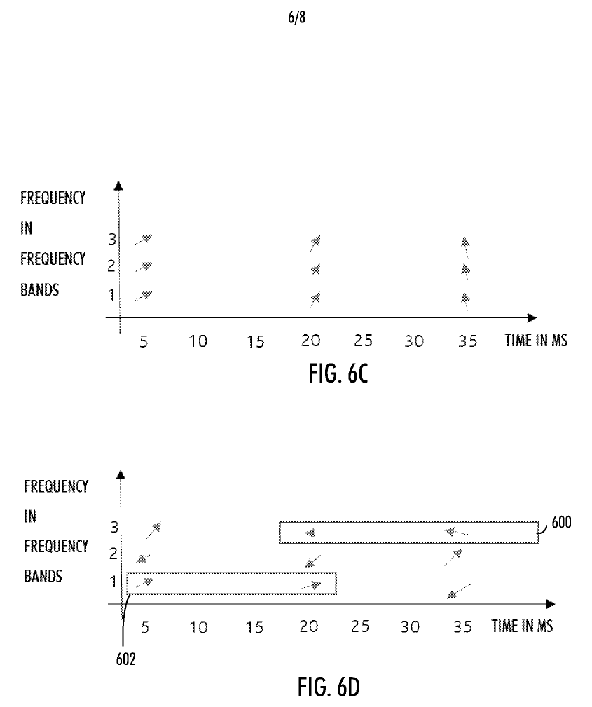

FIGS. 6A-6F illustrate further example embodiments. Spatial audio parameters typically include at least direction parameters. These parameters are typically given in frequency bands and time frames i.e. time frequency tiles. The apparatus performing capturing and/or encoding may analyse directions in short time windows. As an example, there are three frequency bands with time window of 5ms is used in the examples of the FIGS. 6A-6F. FIGS. 6A-6F illustrate directions of frequency bands as a function of time.

FIG. 6A illustrates metadata of audio stream comprising speech and FIG. 6B illustrates metadata of audio stream comprising ambience. As FIGS. 6A and 6B illustrate, speech object has smoothly changing direction metadata whereas ambience has more random directions. In the ambient stream direction metadata, it is possible to determine two areas 600, 602 where the metadata changes are smoother than in other areas.

Due to bitrate constraints, not all the directions can be included in the first metadata transmission. In this example, directions are transmitted only every 15 ms. as illustrated in FIGS. 6C and 6D.

If there is a need to either increase or decrease the speed of the stream of audio data, the apparatus performing capturing and/or encoding may prepare instructions as second metadata how the first metadata is to be adjusted.

Let us study an example of first metadata could be adjusted if there would be a need to decrease the speed of an audio stream.

For example, let us now assume that there is a need for a slow-motion version of the audio. There is a need to interpolate (in some cases extrapolate) directions between the first metadata. For a speech object, normal linear interpolation is clearly the best way to go as can be seen from the original data of FIGS. 6A and 6B and from direction metadata of FIGS. 6C and 6D. The capturing/encoding device may generate second metadata from which a receiving device knows that for the speech object interpolation should be traditional linear interpolation. From the original data of FIGS. 6A and 6B and from direction metadata of FIGS. 6C and 6D for ambience the best interpolation (extrapolation) method is not at all straightforward. However, from the data the capturing/encoding device can determine that any method is as good as any other since the direction metadata is seemingly mostly random, but for the determine two areas 600, 602, linear interpolation gives better results than most other methods. Thus, the second metadata for the ambient audio may indicate that for the two areas 600, 602 linear interpolation is used and for other areas repeating the last received direction is as good as any other method. The resulting received and interpolated direction metadata is illustrated in FIGS. 6E and 6F. FIGS. 6E and 6F show original values 604 and the interpolated values 606.

FIG. 7 illustrates an example of an apparatus 700 comprising means for causing the apparatus 700 to perform one or more of the example embodiments (e.g., the method of FIG. 3) described above.

The apparatus 700 may comprise a circuitry or a chipset applicable for realizing one or more of the example embodiments described above. For example, the apparatus 700 may comprise at least one processor 710. The at least one processor 710 interprets instructions (e.g., computer program instructions) and processes data. The at least one processor 710 may comprise one or more programmable processors. The at least one processor 710 may comprise programmable hardware with embedded firmware and may, alternatively or additionally, comprise one or more application-specific integrated circuits (ASICs).

The at least one processor 710 is coupled to at least one memory 720. The at least one processor is configured to read and write data to and from the at least one memory 720. The at least one memory 720 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 720 stores computer readable instructions 730 that are executed by the at least one processor 710 to perform one or more of the example embodiments described above. For example, non-volatile memory stores the computer readable instructions, and the at least one processor 710 executes the instructions using volatile memory for temporary storage of data and/or instructions. The computer readable instructions may refer to computer program code.

The computer readable instructions may have been pre-stored to the at least one memory 720 or, alternatively or additionally, they may be received, by the apparatus, via an electromagnetic carrier signal and/or may be copied from a physical entity such as a computer program product. Execution of the computer readable instructions by the at least one processor 710 causes the apparatus 700 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 700 may further comprise, or be connected to, an input unit 740. The input unit 740 may comprise one or more interfaces for receiving input. The one or more interfaces may comprise, for example, at least one of: one or more cameras, one or more accelerometers, one or more microphones, one or more buttons and/or one or more touch detection units. Further, the input unit 740 may comprise an interface to which external devices may connect to.

The apparatus 700 may also comprise an output unit 750. The output unit may comprise or be connected to one or more displays capable of rendering visual content, such as a light emitting diode (LED) display, a liquid crystal display (LCD) and/or a liquid crystal on silicon (LCoS) display. The output unit 750 may further comprise one or more audio outputs. The one or more audio outputs may be for example loudspeakers.

The apparatus 700 may further comprise a connectivity unit 760. The connectivity unit 760 enables wireless connectivity to one or more external devices. The connectivity unit 760 comprises at least one transmitter and at least one receiver that may be integrated to the apparatus 700 or that the apparatus 700 may be connected to.

In an embodiment, the at least one transmitter comprises at least one transmission antenna, and the at least one receiver comprises at least one receiving antenna. The connectivity unit 760 may comprise an integrated circuit or a set of integrated circuits that provide wired or wireless communication capability for the apparatus 700. Alternatively, the wireless connectivity may be a hardwired application-specific integrated circuit (ASIC). The connectivity unit 760 may also provide means for performing at least some of the blocks or functions of one or more example embodiments described above. The connectivity unit 760 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 700 may further comprise various components not illustrated in FIG. 7. The various components may be hardware components and/or software components.

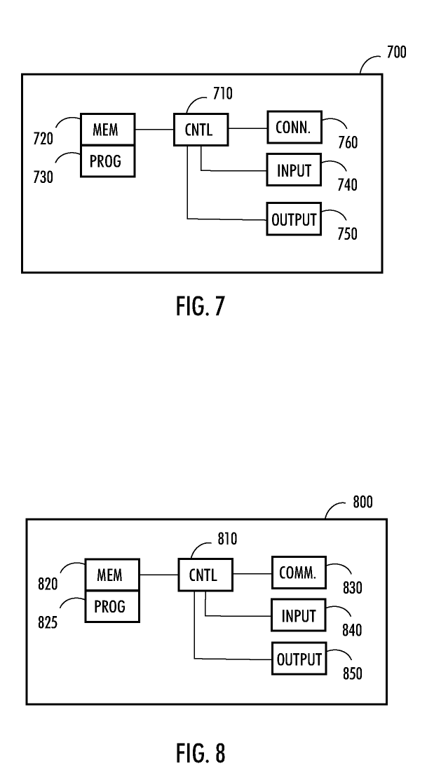

FIG. 8 illustrates an example of an apparatus 800 comprising means for causing the apparatus 800 to perform one or more of the example embodiments (e.g., the method of FIG. 4) described above. For example, the apparatus 800 may be an apparatus such as, or comprising, or comprised in, a user equipment (UE) 100, 102. The user equipment may also be called a wireless communication device, a subscriber unit, a mobile station, a remote terminal, an access terminal, a user terminal, a terminal device, or a user device. The apparatus may also be a VR unit, such as a wearable VR device.

The apparatus 800 may comprise, for example, a circuitry or a chipset applicable for realizing one or more of the example embodiments described above. The apparatus 800 may be an electronic device comprising one or more electronic circuitries. The apparatus 800 may comprise a communication control circuitry 810 such as at least one processor, and at least one memory 820 storing instructions 825 which, when executed by the at least one processor, cause the apparatus 800 to carry out one or more of the example embodiments described above. Such instructions 825 may, for example, include computer program code (software). The at least one processor and the at least one memory storing the instructions may provide the means for providing or causing the performance of any of the methods and/or blocks described above.

The processor is coupled to the memory 820. The processor is configured to read and write data to and from the memory 820. The memory 820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 820 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

The memory 820 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 800 may further comprise or be connected to a communication interface 830, such as a radio unit, comprising hardware and/or software for realizing communication connectivity with one or more wired or wireless communication devices according to one or more communication protocols. The communication interface 830 comprises at least one transmitter (Tx) and at least one receiver (Rx) that may be integrated to the apparatus 800 or that the apparatus 800 may be connected to. The communication interface 830 may provide means for performing some of the blocks and/or functions (e.g., transmitting and receiving) for one or more example embodiments described above. The communication interface 830 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 830 provides the apparatus with radio communication capabilities to communicate in the wireless communication network, for example. The communication interface may, for example, provide a radio interface to one or more UEs 100, 102.

The apparatus 800 may further comprise, or be connected to, an input unit 840. The input unit 840 may comprise one or more interfaces for receiving input. The one or more interfaces may comprise, for example, at least one of: one or more cameras, one or more accelerometers, one or more microphones, one or more buttons and/or one or more touch detection units. Further, the input unit 840 may comprise an interface to which external devices may connect to.

The apparatus 800 may also comprise an output unit 850. The output unit may comprise or be connected to one or more displays capable of rendering visual content, such as a light emitting diode (LED) display, a liquid crystal display (LCD) and/or a liquid crystal on silicon (LCoS) display. The output unit 850 may further comprise one or more audio outputs. The one or more audio outputs may be for example loudspeakers.

It is to be noted that the apparatus 800 may further comprise various components not illustrated in FIG. 8. The various components may be hardware components and/or software components.

As used in this application, the term “circuitry” may refer to one or more or all of the following: a) hardware-only circuit implementations (such as implementations in analog, digital and/or quantum circuitry); and b) combinations of hardware circuit(s) and software, such as (as applicable): i) a combination of analog, digital and/or quantum hardware circuit(s) with software/firmware and ii) any or all portions of hardware processor(s) (including digital and/or quantum processor(s)) with software, and memory(ies) that work together to cause an apparatus, such as a mobile device, computing device, or server, to perform various functions; and c) any or all portions of hardware circuit(s), such as microprocessor(s), processor(s) and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be understandable to a person skilled in the art that, as technology advances, the proposed concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1-19. (canceled)

20. An apparatus comprising:
at least one processor; and
at least one memory storing instructions that, when executed by the at least one processor, cause the apparatus at least to:
obtain at least one stream of audio data comprising first metadata associated with the audio data of the at least one stream;
classify the at least one stream of audio data;
determine, based on the classification, adjustment of the first metadata of the at least one stream of audio data for increased and decreased speed of the at least one stream of audio data;
store information based on the determined adjustment to a second metadata; and
output the at least one stream of audio data with the first and the second metadata.

21. The apparatus according to claim 20, wherein the apparatus is further caused to: encode the second metadata to the at least one stream of audio data.

22. The apparatus according to claim 20, wherein the apparatus is further caused to: encode the second metadata separately from the at least one stream of audio data.

23. The apparatus according to claim 20, wherein the classification of the at least one stream of audio data comprise different classifications for different sections of the stream of audio data.

24. The apparatus according to claim 20, wherein obtained at least one stream of audio data comprises a first stream of audio data classified as speech and a second stream of audio data classified as ambient audio, and wherein the apparatus is further caused to:
determine the adjustment to be averaging of the first metadata of the first and second streams, wherein the first metadata of the first stream is averaged with a longer time-window than the second metadata of the second stream, when the speed of the first and second streams are to be increased; and
determine the adjustment comprises interpolation of the first metadata of the first and second streams, wherein the first metadata of the first stream is interpolated smoother than the first metadata of the second stream, when the speed of the first and second streams are to be decreased.

25. The apparatus according to claim 24, wherein the apparatus is further caused to: classify the at least one stream of audio data as speech when the audio data comprises a single strongest audio source and which is spatially slowly moving based on the first metadata of the at least one stream.

26. The apparatus according to claim 24, wherein the apparatus is further caused to classify a stream of audio data as ambient audio when the audio data has a plurality of audio sources which are spatially fast moving based on the first metadata of the at least one stream.

27. An apparatus comprising:
at least one processor; and
at least one memory storing instructions that, when executed by the at least one processor, cause the apparatus at least to:
receive at least one stream of audio data comprising first metadata associated with the audio data of the stream;
receive second metadata associated with the at least one stream, the second metadata comprising instructions on how the first metadata is to be adjusted for increased and decreased the speed of the stream of audio data;
determine a need to either increase or decrease the speed of the at least one stream of audio data; and
adjust the first metadata of the at least one stream, wherein the adjustment is based on the second metadata and the need to either increase or decrease the speed.

28. The apparatus according to claim 27, wherein the at least one stream comprising first metadata also comprises the second metadata.

29. The apparatus according to claim 27, wherein the adjustment at least one streams of audio data comprises interpolation or averaging of the first metadata.

30. A method comprising:
obtaining at least one stream of audio data comprising first metadata associated with the audio data of the at least one stream;
classifying the at least one stream of audio data;
determining, based on the classification, adjustment of the first metadata of the at least one stream of audio data for increased and decreased speed of the stream of audio data;
storing information based on the determined adjustment to a second metadata; and
outputting the at least one stream of audio data with the first and the second metadata.

31. The method according to claim 30, further comprising encoding the second metadata to the at least one stream of audio data.

32. The method according to claim 30, further comprising encoding the second metadata separately from the at least one stream of audio data.

33. The method according to claim 30, wherein the classification of the at least one stream of audio data comprise different classifications for different sections of the stream of audio data.

34. The method according to claim 30, wherein obtained at least one stream of audio data comprises a first stream of audio data classified as speech and a second stream of audio data classified as ambient audio, and wherein the method further comprises:
determining the adjustment to be averaging of the first metadata of the first and second streams, wherein the first metadata of the first stream is averaged with a longer time-window than the second metadata of the second stream, when the speed of the first and second streams are to be increased; and
determining the adjustment comprises interpolation of the first metadata of the first and second streams, wherein the first metadata of the first stream is interpolated smoother than the first metadata of the second stream, when the speed of the first and second streams are to be decreased.

35. The apparatus according to claim 34, wherein the method further comprises classifying the at least one stream of audio data as speech when the audio data comprises a single strongest audio source and which is spatially slowly moving based on the first metadata of the at least one stream.

36. The apparatus according to claim 34, wherein the method further comprises classifying a stream of audio data as ambient audio when the audio data has a plurality of audio sources which are spatially fast moving based on the first metadata of the at least one stream.

37. A non-transitory computer readable medium comprising program instructions stored thereon for performing at least the following:
obtain at least one stream of audio data comprising first metadata associated with the audio data of the at least one stream;
classify the at least one stream of audio data;
determine, based on the classification, adjustment of the first metadata of the at least one stream of audio data for increased and decreased speed of the at least one stream of audio data;
store information on the determined adjustment to a second metadata; and
output the at least one stream of audio data with the first and the second metadata.
